(19) United States
(12) Patent Application Publication
(10) Pub. No.: US 2019/0279826 A1
(43) Pub. Date: Sep. 12, 2019

(54) METHOD FOR FORMING POLYMER COMPOSITE MATERIAL ON CAPACITOR ELEMENT

(71) Applicant: APAQ TECHNOLOGY CO., LTD., Miaoli County (TW)

(72) Inventor: Chieh LIN, Hsinchu County (TW)

(21) Appl. No.: 16/016,756

(22) Filed: Jun. 25, 2018

(30) Foreign Application Priority Data
Mar. 12, 2018 (TW) 107108295

(51) Int. Cl. H01G 9/042; C09D 5/24; C09D 165/00; C09D 4/00; C09D 7/63; C09D 7/65; H01G 9/00

(52) U.S. Cl. CPC H01G 9/0425; C09D 5/24; C09D 165/00; H01G 9/151; C09D 7/63; C09D 7/65; H01G 9/0036; C09D 4/00

(57) ABSTRACT

A method for forming a polymer composite material on a capacitor element is provided. The method includes a preparing step, an impregnating step, a drying step and a polymerization step. The preparing step includes forming a homogeneous reaction solution including 3,4-ethylenedioxythiophene, an emulsifier, poly(styrenesulfonate), an initiator and water. The impregnating step includes impregnating the capacitor element into the homogeneous reaction solution to form a reaction layer on the capacitor element. The drying step includes heating the reaction layer to remove water in the reaction layer. The polymerization step includes heating the reaction layer to initiate a polymerization reaction between the 3,4-ethylenedioxythiophene and the poly(styrenesulfonate) to form a conductive polymer layer at least including a conductive polymer material.

### BACKGROUND

### 1. Technical Field

The instant disclosure relates to a method for forming a polymer composite material, and in particular, to a method for forming a polymer composite material on a capacitor element.

### 2. Description of Related Art

Capacitors are widely used, in such as consumer appliances, computers, power supplies, communication products and vehicles, and have become one of the indispensable elements in electronic devices. The main roles of the capacitors include filtering, bypassing, rectifying, coupling, decoupling and phase inverting, etc. The capacitors can be in different types according to different materials and purposes, including aluminum electrolytic capacitors, tantalum electrolytic capacitors, laminated ceramic capacitors and thin film capacitors. In the related art, with the advantages of being small in size, large capacitance and excellent frequency characteristics, solid electrolytic capacitors are used to decouple power circuits of central processing units. In the solid electrolytic capacitors, liquid electrolytic solutions are replaced with solid electrolytes such as cathodes. On the other hand, with the advantages of high conductivity and being easily manufactured, conductive polymers have been widely applied to the cathodes of the solid electrolytic capacitors.

The conductive polymers, which can be applied to the cathodes of the solid electrolytic capacitors, include polyaniline (PAni), polypyrrole (PPy), polythiophene (PTh) and derivatives thereof, in which a poly(3,4-ethylenedioxythiophene)-poly(styrenesulfonate) (PEDOT:PSS) composite has excellent conductivity and a lower rate of polymerization compared to other polymers such as the PAni and the PPy. Therefore, the PEDOT:PSS composite can be polymerized at room temperature and make a preparation easier. In addition, compared to other polymers, the PEDOT:PSS composite has better weather resistance and heat resistance. Furthermore, the PEDOT:PSS composite has good dispersibility, low production cost, high transparency and excellent processability. Therefore, it would be a great improvement in electrical properties of the capacitors to use the PEDOT:PSS composite as a component of the conductive polymer layer on the cathodes of the capacitors

However, a method for forming a polymer composite material on a capacitor element is still needed to simplify a manufacturing process of the capacitor and to improve the overall electrical properties of the capacitor.

### SUMMARY

The main object of the instant disclosure is to provide a method for forming a polymer composite material on a capacitor element, where a conductive layer can be formed on the capacitor element by in-situ polymerization and parameters could be controlled during the in-situ polymerization so as to improve the electrical properties of the capacitor.

An embodiment of the instant disclosure provides a method for forming a polymer composite material on a capacitor element which includes a preparing step, an impregnating step, a drying step and a polymerization step. The preparing step includes forming a homogeneous reaction solution containing 3,4-ethylenedioxythiophene, an emulsifier, poly(styrenesulfonate), an initiator and water. The impregnating step includes impregnating the capacitor element into the homogeneous reaction solution to coat the capacitor element with the homogeneous reaction solution to form a reaction layer. The drying step includes heating the reaction layer to remove water in the reaction layer. The polymerization step includes heating the reaction layer to initiate a polymerization reaction between the 3,4-ethylenedioxythiophene and the poly(styrenesulfonate) to form a conductive polymer layer at least including a conductive polymer material.

In an embodiment of the present disclosure, the preparing step further includes dissolving the 3,4-ethylenedioxythiophene and the emulsifier in the water to form a homogenous solution; mixing a poly(styrenesulfonate) solution including poly(styrenesulfonate) with the homogenous solution to form a precursor solution; and adding the initiator into the precursor solution to form the homogeneous reaction solution.

In an embodiment of the present disclosure, the step of dissolving the 3,4-ethylenedioxythiophene and the emulsifier in the water includes stirring at room temperature for 1.5 to 2.5 hours.

In an embodiment of the present disclosure, the homogeneous reaction solution contains 1 part by weight of the 3,4-ethylenedioxythiophene, 0.1 to 10 parts by weight of the emulsifier, 2 to 6 parts by weight of poly(styrenesulfonate), 0.5 to 1.5 parts by weight of the initiator, and 50 to 2000 parts by weight of the water.

In an embodiment of the present disclosure, the emulsifier is selected from the group consisting of: a polyol, hexadecyl trimethyl ammonium bromide, dodecyltrimethylammonium bromide, polyethylene glycol monostearate, sodium dodecyl sulfate, sodium dodecylbenzenesulfonate, oleic acid and derivatives thereof, glycerol monostearate, polyoxyethylene monooleate, poly(oxyethylene) (10) oleyl alcohol ether, sorbitan monolaurate, sorbitan monopalmitate, sorbitan monostearate, sorbitan tristearate, sorbiatan monooleate, sorbitan sesquiolate, sorbitan tribleate, polyoxyethylene oxypropylene oleate, polyoxyethylene sorbitol hexastearate, polyoxyethylene esters of mixed fatty acids and resin acids, polyoxyethylene sorbitol lanolin derivatives, polyoxyethylene alkyl aryl ether, polyoxyethylene sorbitol beeswax derivatives, polyoxyethylene monopalmitate, polyoxyethylene glycol monopalmitate, polyoxyethylene sorbitan tribleate, polyoxyethylene sorbitan tribleate tetraethylene glycol monolaurate, polyoxyethylene monolaurate, polyoxyethylene lauryl ether, polyoxyethylene enemonooleate, hexaethylene glycol monostearate, propylene glycol monostearate, polyoxyethylene oxypropylene stearate, N-cetyl N-ethyl morpholinium ethosulfate, alkyl aryl sulfonate, polyoxypropylene stearate, polyoxyethylene laurylether, polyoxyethylene stearyl alcohol, diethylene glycol monolaurate, ethylene glycol diglycidyl ether, polyethylene glycol diglycidyl ether, propanediol diglycidyl ether, polypropanediol diglycidyl ether, 1,2,3-propanetriol glycidyl ethers, and butanediol diglycidyl ether.

In an embodiment of the present disclosure, the initiator includes at least one persulfate.

In an embodiment of the present disclosure, the persulfate is sodium persulfate, ammonium persulfate or potassium persulfate.

In an embodiment of the present disclosure, the polymerization step further includes: raising the temperature of the reaction layer to 80° C. in 10 minutes and maintaining the temperature of the reaction layer between 80° C. to 100° C. for 25 to 35 minutes to form the conductive polymer material.

In an embodiment of the present disclosure, the drying step further includes: raising the temperature of the reaction layer to 150° C. in 10 minutes and maintaining the temperature of the reaction layer between 140° C. to 160° C. for 25 to 35 minutes to form the conductive polymer layer before the polymerization step.

Advantages of the present disclosure include that based on the method for forming a polymer composite material on a capacitor element, the reaction layer is formed on a surface of the capacitor element by impregnating the capacitor element, and then the reaction layer is heated to initiate the polymerization reaction between the 3,4-ethylenedioxythiophene and the poly(styrenesulfonate) to form the conductive polymer material, such that the efficiency of manufacturing the capacitor can be improved and issues related to short circuits of the capacitor under high pressure can also be overcome.

For further understanding of the techniques, means and effects of the present disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide further understanding of the instant disclosure, and are incorporated in and constitute a part of this specification. The drawings illustrate exemplary embodiments of the instant disclosure and, together with the description, serve to explain the principles of the instant disclosure.

FIG. 1 is a sectional side view of a capacitor using a polymer composite material of an embodiment of the instant disclosure.

FIG. 2 is a sectional side view of a capacitor package structure of an embodiment of the instant disclosure.

FIG. 3 is a perspective view of another capacitor using the polymer composite material of an embodiment of the instant disclosure.

FIG. 4 is a sectional schematic view of another capacitor package structure of an embodiment of the instant disclosure.

FIG. 5 is a flow chart of a method for forming the polymer composite material on a capacitor element of an embodiment of the present disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

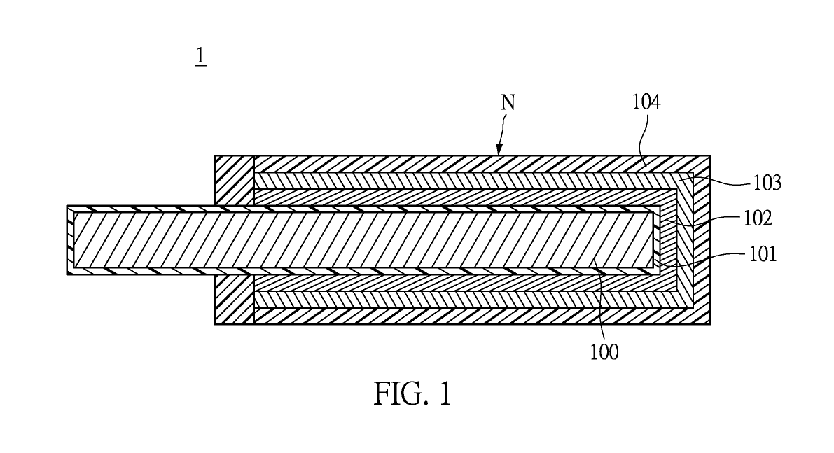

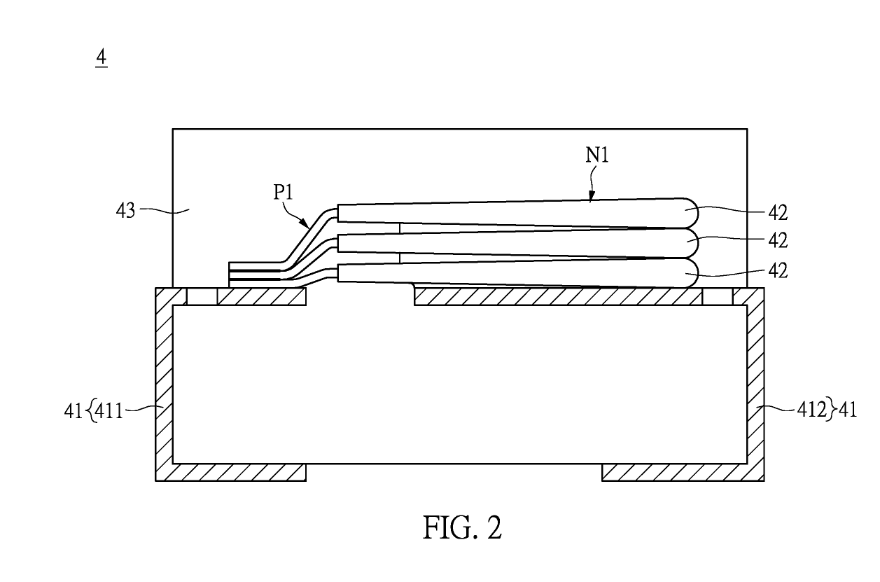

Reference is made to FIG. 1 and FIG. 2. FIG. 1 is a sectional side view of a capacitor using a polymer composite material of an embodiment of the instant disclosure, and FIG. 2 is a sectional side view of a capacitor package structure of an embodiment of the instant disclosure. Specifically, the polymer composite material formed by using a method of the present disclosure can be applied to a conductive polymer layer 102 of a cathode portion N of a capacitor 1. As shown in FIG. 2, the capacitor 1 can be a capacitor unit 42 in a stacked type solid electrolytic capacitor package structure 4.

For example, as shown in FIG. 1, the capacitor 1 may include a metal foil 100, an oxidation layer 101 cladding the metal foil 100, a conductive polymer layer 102 cladding a part of the oxidation layer 101, a carbon paste layer 103 cladding the conductive polymer layer 102 and a silver paste layer 104 cladding the carbon paste layer 103. The structure of the capacitor 1 can be changed or adjusted depending on actual needs. The conductive polymer layer 102 serves as a solid electrolyte of the capacitor 1.

The conductive polymer layer 102 may be formed by using the method of the instant disclosure. Therefore, the capacitor element of the present disclosure may include the metal foil 100 and the oxidation layer 101 thereon as shown in FIG. 1.

As shown in FIG. 2, the stacked type solid electrolytic capacitor 4 includes a plurality of the capacitor units 42 sequentially stacked. In addition, the stacked type solid electrolytic capacitor 4 includes a conductive frame 41. The conductive frame 41 includes a first conductive terminal 411 and a second conductive terminal 412 separated by a predetermined distance from each other. Furthermore, the plurality of the capacitor units 42 sequentially stacked and electrically connected to each other have a first positive portion P1 electrically connected to the first conductive terminal 411 of the corresponding conductive frame 41, and a first negative portion N1 electrically connected to the second conductive terminal 412 of the corresponding conductive frame 41. In addition, a package body 43 clads the plurality of the capacitor units 42 sequentially stacked and electrically connected to each other, to form the stacked type solid electrolytic capacitor 4.

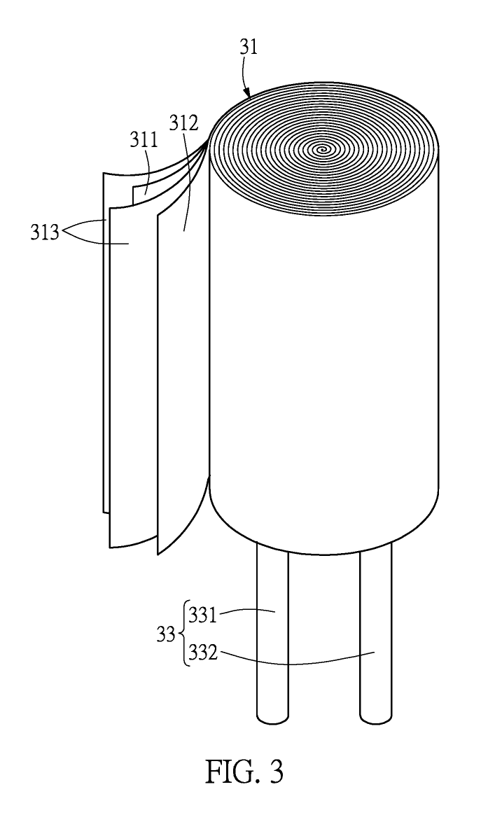

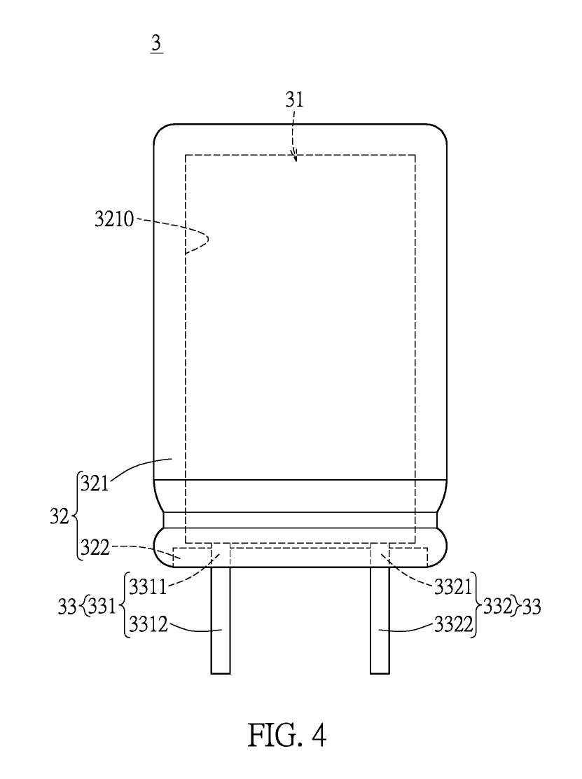

Reference is made to FIG. 3 and FIG. 4. FIG. 3 is a perspective view of another capacitor using the polymer composite material of an embodiment of the instant disclosure, and FIG. 4 is a side view of another capacitor package structure of an embodiment of the instant disclosure. In FIG. 3 and FIG. 4, the capacitor 1 is a capacitor unit in a winding type solid electrolytic capacitor package 3.

As shown in FIG. 4, the winding type solid electrolytic capacitor 3 includes a winding type component 31, a package component 32 and a conductive component 33. Referring to FIG. 3, the winding type component 31 includes a winding type positive conductive foil 311, a winding type negative conductive foil 312 and two winding type isolation foils 313. One of the two winding type isolation foils 313 is disposed between the winding type positive conductive foil 311 and the winding type negative conductive foil 312, and one of the winding type positive conductive foil 311 and the winding type negative conductive foil 312 is disposed between the two winding type isolation foils 313. The winding type isolation foils 313 can be separation papers or paper foils attached with the polymer composite material by the method of the present disclosure. However, the instant disclosure is not limited thereto, and the material of the winding type isolation foils 313 can be changed. In the method provided in another embodiment of the present disclosure, the polymer composite material may be formed on at least one of the winding type positive conductive foil 311, the winding type negative conductive foil 312 and the two winding type isolation foils 313.

Referring to FIG. 4 again, the winding type component 31 is clad in the package component 32. The package component 32 includes a capacitor casing structure 321, such as aluminum cases or other metal cases, and a bottom sealing structure 322. The capacitor casing structure 321 has an accommodating space 3210 for accommodating the winding type component 31, and the bottom sealing structure 322 is disposed at the bottom of the capacitor casing structure 321 to seal the accommodating space 3210. In addition, the package component 32 may be a package formed by other proper insulating materials.

The conductive component 33 includes a first conductive pin 331 electrically contacting the winding type positive conductive foil 311 and a second conductive pin 332 electrically contacting the winding type negative conductive foil 312. The first conductive pin 331 has a first embedded portion 3311 clad in the package component 32 and a first exposed portion 3312 exposed outside the package component 32. The second conductive pin 332 has a second embedded portion 3321 clad in the package component 32 and a second exposed portion bottom sealing structure 3322 exposed outside the package component 32.

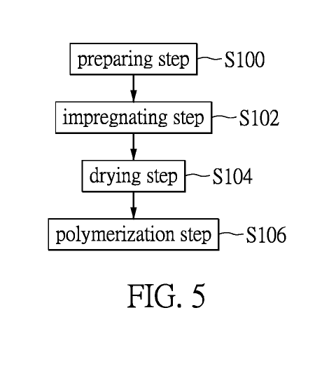

Reference is made to FIG. 5. FIG. 5 is a flow chart of the method for forming the polymer composite material on the capacitor element of the instant disclosure. The method includes a preparing step (step S100), an impregnating step (step S102), a drying step (step S104) and a polymerization step (step S106).

In the preparing step, a homogeneous reaction solution containing 3,4-ethylenedioxythiophene, an emulsifier, poly(styrenesulfonate), an initiator and water is formed. The homogeneous reaction solution is a precursor solution for forming the conductive polymer material (polymer composite material). After chemical reactions occur between components in the homogeneous reaction solution, the conductive polymer material would be formed. Specifically, with the presence of the initiator, a polymerization reaction between the 3,4-ethylenedioxythiophene and the poly(styrenesulfonate) in the homogeneous reaction solution is initiated, and poly(3,4-ethylenedioxythiophene) polystyrene sulfonate (PEDOT:PSS) is thereby formed.

In the instant disclosure, the homogeneous reaction solution contains 1 part by weight of the 3,4-ethylenedioxythiophene, 0.1 to 10 parts by weight of the emulsifier, 2 to 6 parts by weight of the poly(styrenesulfonate), 0.5 to 1.5 parts by weight of the initiator and 50 to 2000 parts by weight of the water. Further, the homogeneous reaction solution can contain other additives, which may be an adhesive or a binder, such as polyvinyl alcohol. In the embodiments of the present disclosure, an alcohol can be a substitute for the water serving as a solvent. Furthermore, it should be noted that using the water as the solvent not only can be a low cost, environmentally friendly option, but can effectively overcome issues related to short circuits of a solid capacitor under high pressure. Compared with an conventional PEDOT:PSS dispersion, since the present disclosure adopts water as the solvent in the homogeneous reaction solution, the invention of the present disclosure will not have issues related to shelf life.

The emulsifier can effectively improve dispersibility of the components in the solvent in the homogeneous reaction solution. Therefore, with the use of the homogeneous reaction solution, mechanical stirring is not required any longer, and thus complexity and a cost of a manufacturing process would be reduced. The emulsifier used in the homogeneous reaction solution can be selected from a group consisting of: a polyol, hexadecyl trimethyl ammonium bromide (cetyltrimethylammonium bromide, CTAB), dodecyltrimethylammonium bromide (DTAB), polyethylene glycol (DEG) monostearate, sodium dodecyl sulfate (SDS), sodium dodecylbenzenesulfonate (SDBS), oleic acid and derivatives thereof, glycerol monostearate, polyoxyethylene monooleate, poly(oxyethylene) (10) oleyl alcohol ether, sorbitan monolaurate, sorbitan monopalmitate, sorbitan monostearate, sorbitan tristearate, sorbiatan monooleate, sorbitan sesquiolate, sorbitan tribleate, polyoxyethylene oxypropylene oleate, polyoxyethylene sorbitol hexastearate, polyoxyethylene esters of mixed fatty acids and resin acids, polyoxyethylene sorbitol lanolin derivatives, D-sorbital, polyoxyethylene alkyl aryl ether, polyoxyethylene sorbitol beeswax derivatives, polyoxyethylene monopalmitate, polyoxyethylene glycol monopalmitate, polyoxyethylene oxypropylene oleate, tetraethylene glycol monolaurate, polyoxyethylene monolaurate, polyoxyethylene lauryl ether, polyoxyethylene enemonooleate, polyoxyethylene monooleate, hexaethylene glycol monostearate, propylene glycol fatty acid ester polyoxyethylene oxypropylene stearate, N-cetyl N-ethyl morpholinium ethosulfate, alkyl aryl sulfonate, polyoxypropylene stearate, polyoxyethylene laurylether, polyoxyethylene stearyl alcohol, diethylene glycol monolaurate, sorbitan monolaurate, sorbitan monopalmitate, ethylene glycol diglycidyl ether, polyethylene glycol diglycidyl ether, propanediol diglycidyl ether, polypropanediol diglycidyl ether, 1,2,3-propanetriol glycidyl ethers, and butanediol diglycidyl ether. Preferably, the emulsifier is a polyol. More preferably, the emulsifier is polyethylene glycol or polypropylene glycol. It should be noted that a compound having surfactant functions can be used as the emulsifier, and the types of the emulsifier are not limited in the instant disclosure. In addition, multiple types of the emulsifiers can be used in the solution at the same time.

The initiator in the homogeneous reaction solution can be an oxidant. In the embodiments of the present disclosure, the initiator contains at least one persulfate. The persulfate can be sodium persulfate, ammonium persulfate or potassium persulfate. In fact, iron salts are generally used as an initiator in the method for forming polymer composite materials in the prior art. However, in the instant disclosure, the electrical properties of the capacitor using the polymer composite material may be greatly improved, by using of the persulfate as the initiator and the poly(styrenesulfonate) (PSS) as one of the reactants (as a dopant) in the manufacturing process.

For example, compared to the prior art, adopting the iron salts as the initiator and p-Toluenesulfonic acid as one of the reactants (as a dopant), the present disclosure can reduce leakage current (LC) of a capacitor (e.g., a 25V capacitor) by using the persulfate as the initiator and using the PSS as the dopant.

The preparing step (step S100) includes the following steps: dissolving the 3,4-ethylenedioxythiophene and the emulsifier in water to form a homogenous solution; mixing a PSS solution including the PSS with the homogenous solution to form a precursor solution; and adding the initiator into the precursor solution to form the homogeneous reaction solution. In addition, a step of stirring at room temperature for 1.5 to 2.5 hours is further included in the step of dissolving the 3,4-ethylenedioxythiophene and the emulsifier in the water.

Next, in the impregnating step (step S102), the capacitor element is impregnated into the homogeneous reaction solution to coat the capacitor element with the homogeneous reaction solution to form a reaction layer. Specifically, in the instant disclosure, the unpolymerized reactants, i.e., the 3,4-ethylenedioxythiophene and the poly(styrenesulfonate) in the homogeneous reaction solution, are disposed on the capacitor element. In the impregnating step, the homogeneous reaction solution is coated on the surface of the capacitor element and infiltrates into a porous structure (such as pores or voids) of the capacitor element.

Specifically, the capacitor element is impregnated into a container containing the homogeneous reaction solution, so as to dispose the homogeneous reaction solution on the capacitor element. After the homogeneous reaction solution is disposed on the capacitor element and the reaction layer is formed, the capacitor element with the reaction layer can be removed from the container.

In order to facilitate the coating of the homogeneous reaction solution on the capacitor element or the infiltration of the homogeneous reaction solution into the porous structure of the capacitor element, an ultrasonicator can be used in the step S102 to help forming the reaction layer.

After the impregnating step, the capacitor element is heated in the drying step (step S104). Specifically, the drying step includes heating the reaction layer to remove water in the reaction layer. The drying step further includes raising the temperature of the reaction layer to 150° C. in 10 minutes and maintaining the temperature of the reaction layer between 140° C. to 160° C. for 25 to 35 minutes to form the conductive polymer layer.

In the polymerization step (step S106), by heating the reaction layer, the polymerization reaction between the 3,4-ethylenedioxythiophene and the poly(styrenesulfonate) is initiated to form the conductive polymer material. In other words, the conductive polymer material is formed by in-situ polymerization. The polymerization step can further include: raising the temperature of the reaction layer to 80° C. in 10 minutes and maintaining the temperature of the reaction layer between 80° C. to 100° C. for 25 to 35 minutes to form the conductive polymer material.

Specifically, in the polymerization step, with the presence of the initiator, the polymerization reaction between the 3,4-ethylenedioxythiophene and the poly(styrenesulfonate) in the homogeneous reaction solution is initiated, and thereby a PEDOT:PSS composite is formed. In other words, the conductive polymer material in the instant disclosure is the PEDOT:PSS composite.

### Effect of the Embodiments

Advantages of the present disclosure include that, based on the method for forming a polymer composite material on a capacitor element, a reaction layer is formed on a surface of the capacitor element by impregnating the capacitor element, and then the reaction layer is heated to initiate the polymerization reaction between 3,4-ethylenedioxythiophene and poly(styrenesulfonate) to form a conductive polymer material, such that the efficiency of manufacturing the capacitor can be improved and issues related to short circuits of the capacitor under high pressure can also be overcome.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

1. A method for forming a polymer composite material on a capacitor element, comprising:
a preparing step including: forming a homogeneous reaction solution containing 3,4-ethylenedioxythiophene, an emulsifier, poly(styrenesulfonate), an initiator and water;
an impregnating step including: impregnating the capacitor element into the homogeneous reaction solution to coat the capacitor element with the homogeneous reaction solution to form a reaction layer;
a drying step including: heating the reaction layer to remove water in the reaction layer; and
a polymerization step including: heating the reaction layer to initiate a polymerization reaction between the 3,4-ethylenedioxythiophene and the poly(styrenesulfonate) to form a conductive polymer layer at least including a PEDOT:PSS composite;
wherein the preparing step further includes:
dissolving the 3,4-ethylenedioxythiophene and the emulsifier in the water to form the homogenous reaction solution;
mixing a poly(styrenesulfonate) solution including the poly(styrenesulfonate) with the homogenous reaction solution to form a precursor solution; and
adding the initiator into the precursor solution to form the homogeneous reaction solution.

2. (canceled)

3. The method according to claim 12, wherein the step of dissolving the 3,4-ethylenedioxythiophene and the emulsifier in the water includes stirring at room temperature for 1.5 to 2.5 hours.

4. The method according to claim 1, wherein the homogeneous reaction solution contains 1 part by weight of the 3,4-ethylenedioxythiophene, 0.1 to 10 parts by weight of the emulsifier, 2 to 6 parts by weight of the poly(styrenesulfonate), 0.5 to 1.5 parts by weight of the initiator, and 50 to 2000 parts by weight of the water.

5. The method according to claim 1, wherein the emulsifier is selected from the group consisting of: a polyol, hexadecyl trimethyl ammonium bromide, dodecyltrimethylammonium bromide, polyethylene glycol monostearate, sodium dodecyl sulfate, sodium dodecylbenzenesulfonate, oleic acid and derivatives thereof, glycerol monostearate, polyoxyethylene monooleate, poly(oxyethylene) (10) oleyl alcohol ether, sorbitan monolaurate, sorbitan monopalmitate, sorbitan monostearate, sorbitan tristearate, sorbiatan monooleate, sorbitan sesquiolate, sorbitan tribleate, polyoxyethylene oxypropylene oleate, polyoxyethylene sorbitol hexastearate, polyoxyethylene esters of mixed fatty acids and resin acids, polyoxyethylene sorbitol lanolin derivatives, polyoxyethylene alkyl aryl ether, polyoxyethylene sorbitol beeswax derivatives, polyoxyethylene monopalmitate, polyoxyethylene glycol monopalmitate, polyoxyethylene sorbitan tribleate, polyoxyethylene sorbitan tribleate tetraethylene glycol monolaurate, polyoxyethylene monolaurate, polyoxyethylene lauryl ether, polyoxyethylene enemonooleate, hexaethylene glycol monostearate, propylene glycol monostearate, polyoxyethylene oxypropylene stearate, N-cetyl N-ethyl morpholinium ethosulfate, alkyl aryl sulfonate, polyoxypropylene stearate, polyoxyethylene laurylether, polyoxyethylene stearyl alcohol, diethylene glycol monolaurate, ethylene glycol diglycidyl ether, polyethylene glycol diglycidyl ether, propanediol diglycidyl ether, polypropanediol diglycidyl ether, 1,2,3-propanetriol glycidyl ethers, and butanediol diglycidyl ether.

6. The method according to claim 1, wherein the initiator includes at least one persulfate.

7. The method according to claim 6, wherein the persulfate is sodium persulfate, ammonium persulfate or potassium persulfate.

8. The method according to claim 1, wherein the polymerization step further includes: raising the temperature of the reaction layer to 80° C. in 10 minutes and maintaining the temperature of the reaction layer between 80° C. to 100° C. for 25 to 35 minutes to form the conductive polymer material.

9. The method according to claim 1, wherein the drying step further includes: raising the temperature of the reaction layer to 150° C. in 10 minutes and maintaining the temperature of the reaction layer between 140° C. to 160° C. for 25 to 35 minutes to form the conductive polymer layer before the polymerization step.
